(19) United States
(12) Patent Application Publication
(10) Pub. No.: US 2012/0188778 A1
(43) Pub. Date: Jul. 26, 2012

(54) SEAT-BELT BUCKLE WITH A SENSOR/ILLUMINATION SUBASSEMBLY

(75) Inventors: Sibylle Buettner, Unna (DE); Frank Grunwald, Oberursel (DE); Harry Skarpil, Dortmund (DE); Stephan Risch, Weiterstadt (DE); Bernhard Schmid, Friedberg (DE)

(73) Assignees: Continental Automotive GMBH, Hannover (DE); Continental Teves AG & Co., OHG, Frankfurt (DE)

(21) Appl. No.: 13/498,960

(22) PCT Filed: Oct. 1, 2010
(86) PCT No.: PCT/EP10/64679

§ 371 Date: Apr. 11, 2012

(30) Foreign Application Priority Data
Oct. 1, 2009 (DE) 10 2009 047 937.6

(51) Int. Cl. B60R 22/00; B60Q 1/00

(52) U.S. Cl. 362/487; 24/591.1

(57) ABSTRACT

A seat-belt buckle for securing persons in motor vehicles, including at least one sensor unit which is designed in such a manner that it can detect the closure state of the seat-belt buckle, the seat-belt buckle having an illumination unit which is integrated, together with the sensor unit, in a common sensor/illumination subassembly.

### CROSS REFERENCE TO RELATED APPLICATIONS

This application is the U.S. National Phase Application of PCT International Application No. PCT/EP2010/064679, filed Oct. 1, 2010, which claims priority to German Patent Application No. 10 2009 047 937.6, filed Oct. 1, 2009, the contents of such applications being incorporated by reference herein.

### FIELD OF THE INVENTION

The invention relates to a seat-belt buckle comprising at least one sensor unit which is designed in such a manner that it can detect the closure state of the seat-belt buckle, and to the use of the seat-belt buckle in motor vehicles.

### BACKGROUND OF THE INVENTION

Seat-belt buckles having sensor units which detect the closure state of the seat-belt-buckle are known, for example from the documents DE 10 2006 061 033 A1, which is incorporated by reference, and WO 2004/065843 A2, which is incorporated by reference.

Seat-belt buckles having illumination units are likewise known, as disclosed, for example, in the documents DE 10 2007 047 704 A1, DE 197 29 567 C1 and DE 10 2006 008 251 A1, which are all incorporated by reference.

### SUMMARY OF THE INVENTION

The invention proposes a seat-belt buckle which is relatively cost-effective and/or can be mounted in a simple manner and/or is compact and here has both a sensor unit and an illumination unit.

This is achieved, according to aspects of the invention, by the seat-belt buckle comprising at least one sensor unit which is designed in such a manner that it can detect the closure state of the seat-belt buckle, wherein the seat-belt buckle has an illumination unit which is integrated, together with the sensor unit, in a common sensor/illumination subassembly.

The sensor/illumination subassembly is preferably designed in such a manner that it can be installed in the seat-belt buckle in preassembled form.

The common sensor/illumination subassembly is preferably understood as meaning a sensor/illumination module.

It is preferred for the sensor/illumination subassembly to comprise a base element which is, in particular, in the form of a leadframe on which the sensor unit and the illumination unit are arranged.

The illumination unit preferably comprises at least one illumination element, which is in the form of a light-emitting diode in particular, and an optical waveguide element which is designed and arranged in such a manner that it guides light from the illumination element to at least one seat-belt buckle actuation button. The sensor unit and the at least one illumination element of the illumination unit are each or together particularly preferably in the form of an electronic SMD (surface-mounted device) component.

The seat-belt buckle actuation button is expediently optically scattering and/or transparent or semi-transparent, in particular is made of plastic.

It is preferred for the optical waveguide element to have a convex optical configuration, in particular an optical lens, on the light-incident side on which the illumination element is assigned to the optical waveguide element, and to have a concave optical configuration, in particular an optical lens, on the light-exit side. It is particularly preferred for the optical waveguide element to be integrated in a housing part, very particularly preferably in a housing shell, for example by means of injection molding, the optical waveguide element preferably being expediently arranged substantially centrally in or on the housing part.

It is expedient for the optical waveguide element to be in the form of a glass fiber element in which the convex and concave optical configurations are integrated.

The seat-belt buckle preferably has an at least three-wire cable connection which is connected, in an electrically conductive manner, to the base element which is in the form of a leadframe and on which the sensor unit is arranged and is connected to the cable connection in an electrically conductive manner, the illumination unit which is directly connected to the cable connection or to the leadframe in an electrically conductive manner being arranged, in particular, in the region of the cable connection.

The sensor unit expediently comprises at least one magnetic field sensor element, in particular a Hall element, and a permanent magnet for detecting the closure state of the seat-belt buckle.

It is preferred for the sensor/illumination subassembly to comprise a housing segment of the seat-belt buckle, in particular with latching elements for fastening or mounting the sensor/illumination subassembly in the seat-belt buckle.

The at least one illumination element of the illumination unit is preferably driven on the basis of the closure state of the seat-belt buckle.

The seat-belt buckle can preferably assume the “open” and “closed” closure states, the “open” closure state being detected by the sensor unit when the closer of the seat-belt is not or is not completely or sufficiently latched into the seat-belt buckle or is not connected to the latter with complete engagement, and the “closed” closure state being detected by the sensor unit when the closer of the seat-belt is completely latched into the seat-belt buckle or is connected to the latter with complete engagement.

It is preferred for the illumination unit to drive the illumination element in such a manner that it illuminates in the event of an “open” closure state detected by the sensor unit, and for the illumination element to be driven in such a manner that it does not illuminate if the sensor unit detects a “closed” closure state. In this case, the illumination element is driven, in particular, in such a manner that it is continuously illuminated when the ignition of the motor vehicle is switched off and flashes when the ignition of the motor vehicle is switched on, in each case if the closure state is “open”. However, if the vehicle is locked or the doors of the passenger compartment are locked, the illumination unit is switched off in order to avoid unnecessary energy consumption.

It is expedient for the illumination unit to comprise two or more different illumination elements having different colors, for example a green illumination element and a red illumination element, these different illumination elements being driven on the basis of the closure state detected by the sensor unit. The seat-belt buckle actuation button is thus also illuminated, for example in “green”, in the “closed” state, which may be helpful in darkness. The “open” closure state is particularly preferably indicated with the illumination of a red illumination element and the “closed” closure state is particularly preferably indicated with the illumination of a green illumination element, at least the seat-belt buckle actuation button being very particularly preferably illuminated in a corresponding manner in each case.

A separate optical waveguide element which supplies light from the respective assigned illumination element to the seat-belt buckle actuation button is preferably respectively assigned to the different illumination units.

The driving of the one or more illumination elements on the basis of the closure state of the seat-belt buckle is expediently carried out in an electronic control unit which is accordingly designed for this purpose, is externally arranged and is connected to the seat-belt buckle via the cable connection or is alternatively integrated in the sensor unit or the illumination unit.

The invention also relates to the sensor/illumination subassembly.

The invention additionally relates to the use of the seat-belt buckle in motor vehicles.

### BRIEF DESCRIPTION OF THE DRAWINGS

The invention is best understood from the following detailed description when read in connection with the accompanying drawings. Included in the drawings is the following figures:

FIG. 1 schematically shows an exemplary embodiment of a seat-belt buckle with a sensor/illumination subassembly,

FIG. 2 schematically shows an alternative, exemplary illustration of the sensor/illumination subassembly in a seat-belt buckle housing,

FIG. 3 schematically shows an exemplary embodiment of a sensor/illumination subassembly with an optical waveguide element,

FIG. 4 schematically shows an alternative exemplary embodiment of the sensor/illumination subassembly without an optical waveguide element,

FIG. 5 schematically shows an exemplary sensor/illumination subassembly without an illumination element and with an open housing,

FIG. 6 schematically shows a sensor/illumination subassembly completely without a housing,

FIG. 7 schematically shows an exemplary leadframe with a sensor unit, and

FIG. 8 schematically shows an associated, exemplary embodiment of the cable connection.

### DETAILED DESCRIPTION OF THE PREFERRED EMBODIMENTS

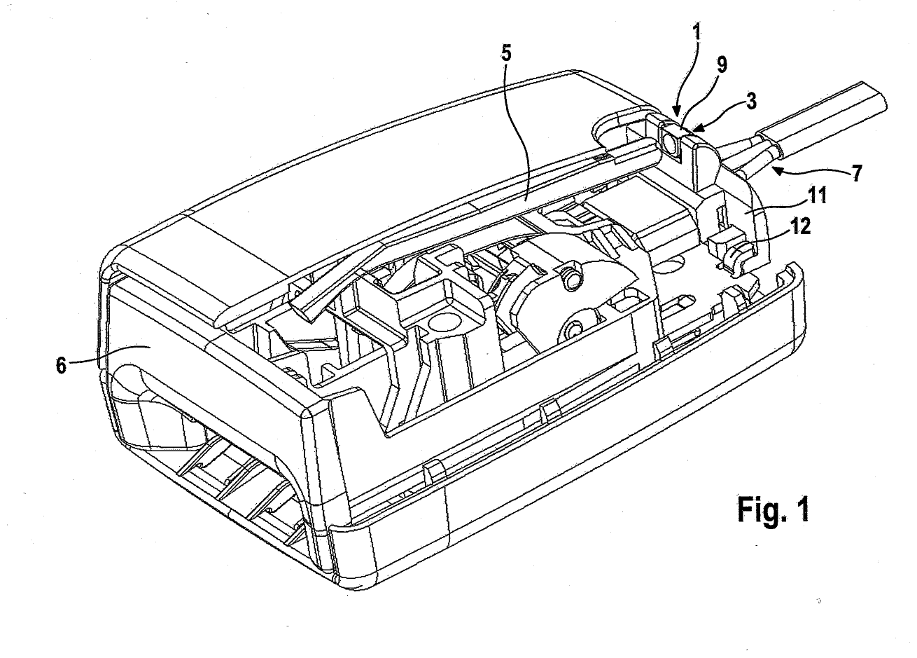

FIG. 1 illustrates an exemplary seat-belt buckle with a sensor/illumination subassembly 1, comprising an illumination unit 3, with a light-emitting diode 9 and an optical waveguide element 5. The sensor unit cannot be seen since it is covered by the other components of the seat-belt buckle. The sensor/illumination subassembly 1 is supplied with electrical energy by a three-wire cable connection 7. The optical waveguide element 5 guides light from the light-emitting diode 9 to the seat-belt buckle actuation button 6 (illustrated in a non-actuated state) so that the latter is illuminated or can be optically seen better.

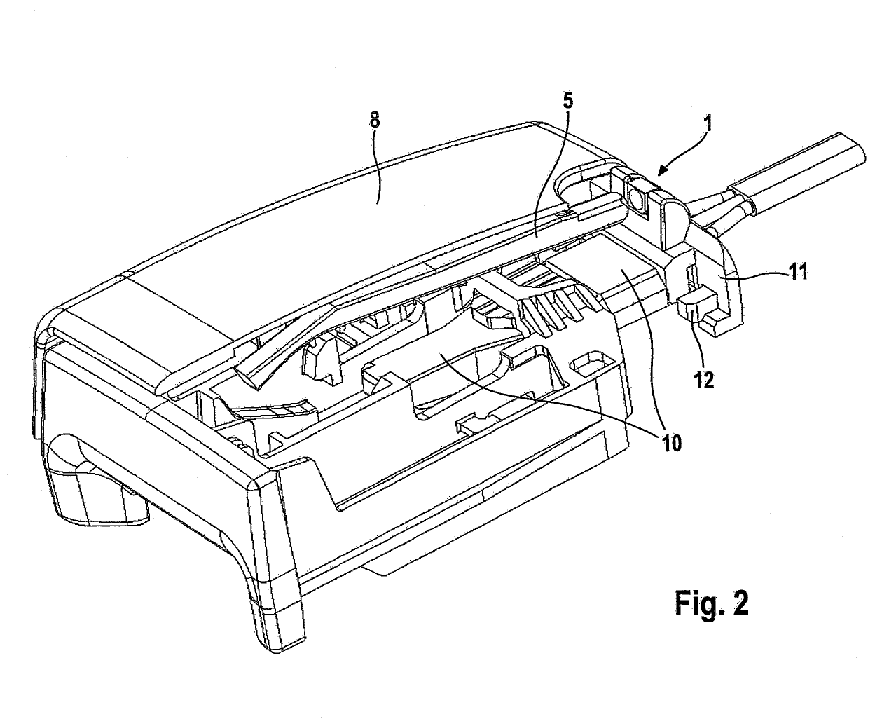

FIG. 2 shows the exemplary seat-belt buckle from FIG. 1, a few other internal components of the seat-belt buckle no longer being illustrated, and the housing 10 of the sensor/illumination subassembly 1 and its positioning in the seat-belt buckle thus being able to be seen better. The sensor/illumination subassembly is designed in such a manner that it can be jointly installed in a relatively simple manner in the seat-belt buckle in the form of an integrated subassembly, for example including the optical waveguide element 5, the latter alternatively also being able to be separately mounted or being able to be integrated in the housing shell 8. By way of example and for the purpose of simplified mounting, the sensor/illumination subassembly 1 comprises a housing segment 11 of the seat-belt buckle with latching elements 12.

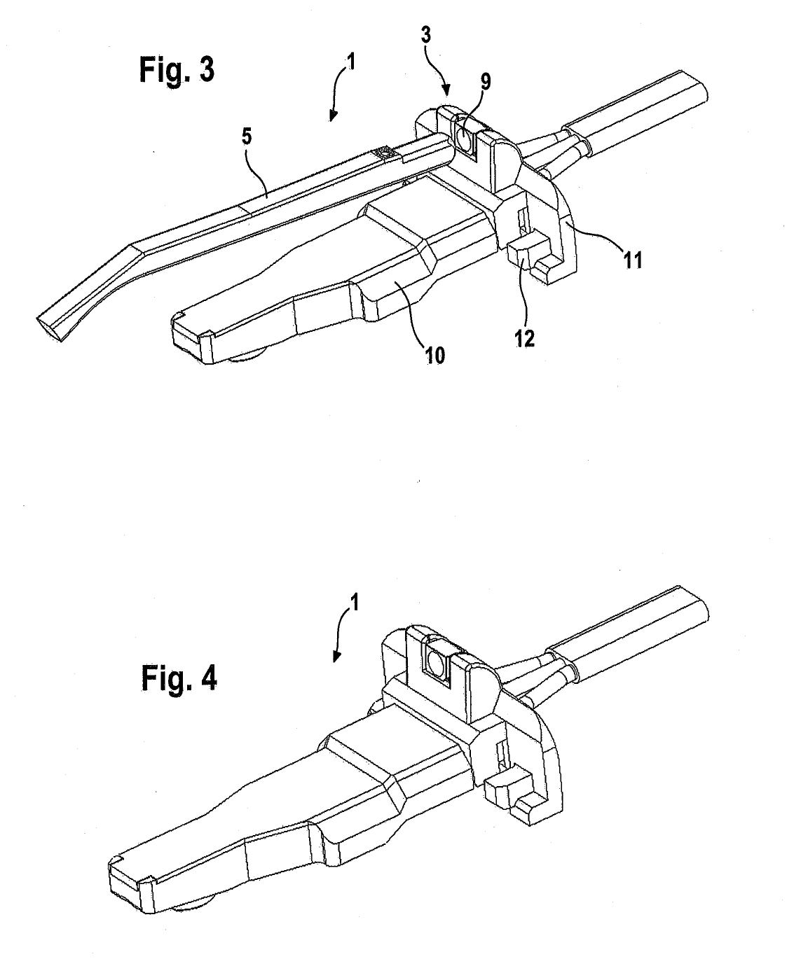

FIG. 3 illustrates an exemplary embodiment of the sensor/illumination subassembly 1, comprising an illumination unit 3, with a light-emitting diode 9 as the illumination element, and with an optical waveguide element 5, and comprising a sensor unit, which is arranged in the housing 10, and a housing segment 11 of the seat-belt buckle with latching elements 12 for fitting and fastening in the seat-belt buckle (not illustrated).

FIG. 4 shows an alternative exemplary embodiment of the sensor/illumination subassembly 1 without an optical waveguide element.

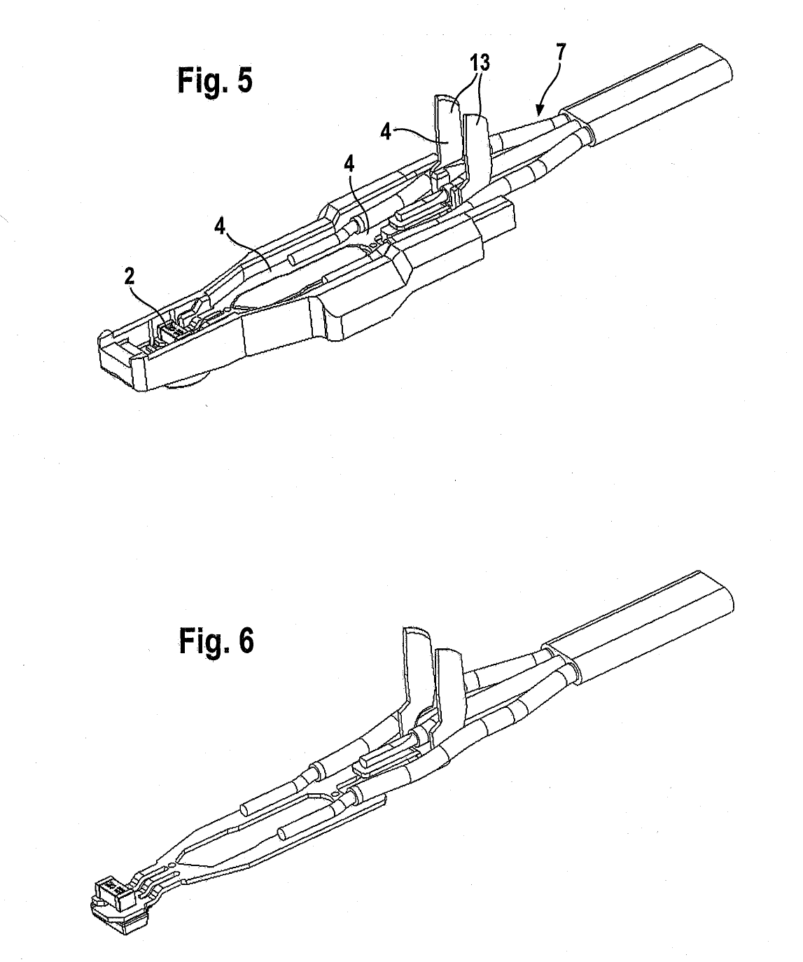

FIG. 5 shows, by way of example, the metal leadframe 4 of the sensor/illumination subassembly, on which the sensor unit 2 is arranged, and the segments 13 of which are provided for the purpose of connecting the illumination unit (not illustrated here). The electrical contact-connections of the wires of the cable connection 7 to the leadframe 4 can also be seen.

FIG. 6 illustrates the exemplary embodiment from FIG. 5 without housing parts.

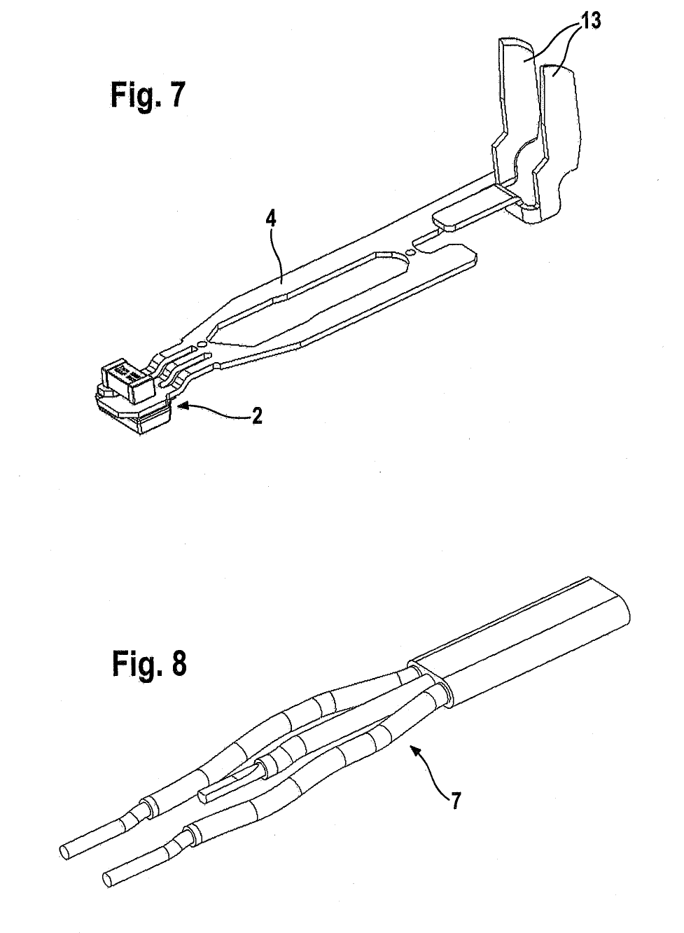

FIG. 7 shows, by way of example, the leadframe 4 with segments 13 for contact-connecting and fastening the illumination unit (not illustrated here). The sensor unit 2 which is fastened to the leadframe 4 and is contact-connected in an electrically conductive manner via the latter is also illustrated.

FIG. 8 illustrates, by way of example, the wire cable connection 7 for a common sensor/illumination unit of a seat-belt buckle.

1.-13. (canceled)

14. A seat-belt buckle for securing persons in motor vehicles, comprising:
at least one sensor unit which is designed in such a manner that it can detect a closure state of the seat-belt buckle; and
an illumination unit which is integrated, together with the sensor unit, in a common sensor/illumination subassembly.

15. The seat-belt buckle as claimed in claim 14, wherein the sensor/illumination subassembly is adapted so that it can be installed in the seat-belt buckle in preassembled form.

16. The seat-belt buckle as claimed in claim 14, wherein the sensor/illumination subassembly comprises a base element in the form of a leadframe on which the sensor unit and the illumination unit are arranged.

17. The seat-belt buckle as claimed in claim 16, wherein the seat-belt buckle has an at least three-wire electrical cable connection which is connected, in an electrically conductive manner, to the base element and is connected to the cable connection in an electrically conductive manner, the illumination unit which is directly connected to the cable connection or to the leadframe in an electrically conductive manner being arranged in the region of the cable connection.

18. The seat-belt buckle as claimed in claim 14, wherein the illumination unit comprises at least one illumination element, and an optical waveguide element to guide light from the illumination element to at least one seat-belt buckle actuation button.

19. The seat-belt buckle as claimed in claim 18, wherein the illumination element is a light-emitting diode.

20. The seat-belt buckle as claimed in claim 18, wherein the sensor unit and the illumination element of the illumination unit are each or together in the form of an electronic SMD component.

21. The seat-belt buckle as claimed in claim 18, wherein the optical waveguide element has a convex optical configuration, comprising an optical lens, on the light-incident side on which the illumination element is assigned to the optical waveguide element, and has a concave optical configuration on a light-exit side.

22. The seat-belt buckle as claimed in claim 21, wherein the optical waveguide element is in the form of a glass fiber element in which the convex and concave optical configurations are integrated.

23. The seat-belt buckle as claimed in claim 14, wherein the sensor/illumination subassembly comprises a housing segment of the seat-belt buckle with latching elements.

24. The seat-belt buckle as claimed in claim 14, wherein the at least one illumination element of the illumination unit is driven on the basis of the closure state of the seat-belt buckle.

25. The seat-belt buckle as claimed in claim 14, wherein the illumination unit drives the illumination element in such a manner that it illuminates in the event of an “open” closure state detected by the sensor unit, and the illumination element is driven in such a manner that it does not illuminate if the sensor unit detects a “closed” closure state.

26. The seat-belt buckle as claimed in claim 14, wherein the illumination unit comprises two or more different illumination elements having different colors, the different illumination elements being driven on the basis of the closure state detected by the sensor unit.

27. The use of the seat-belt buckle as claimed in claim 14 in motor vehicles.
